(19) United States
(12) Patent Application Publication
(10) Pub. No.: US 2012/0243110 A1
(43) Pub. Date: Sep. 27, 2012

(54) Display Magnification and Protection Device

(76) Inventor: Bobby Robinson, Waxahachie, TX (US)

(21) Appl. No.: 13/282,524

(22) Filed: Oct. 27, 2011

Related U.S. Application Data
(60) Provisional application No. 61/467,135, filed on Mar. 24, 2011.

(51) Int. Cl. G02B 25/00; G02B 7/02; G02B 3/08

(52) U.S. Cl. 359/742

(57) ABSTRACT

A screen magnification and protection device for the display of a portable electronic device. The device comprises a transparent magnifying sheet with a front surface, a rear surface and an overall geometric shape. The rear surface comprises a light coating of adhesive to facilitate removable securement to a display. The magnifying sheet is a lens that magnifies images and text on the display. This assists far-sighted users with the operation of their electronic device. In addition to magnification, the device also acts as a screen protector and thereby reduces the likelihood the display will be damaged by debris.

### CROSS REFERENCE TO RELATED APPLICATION

This application claims the benefit of U.S. Provisional Application No. 61/467,135 filed on Mar. 24, 2011, entitled “Clear View.”

### BACKGROUND OF THE INVENTION

1. Field of the Invention

The present invention relates to a portable electronic device accessory. More specifically, it relates to a combination magnification device and screen protector for the digital screen of a portable device. The invention provides a user with a covering for a display that protects it from debris and dirt while also offering magnification of underlying text and images.

Many portable electronic devices are designed to be handheld, e.g. cellphones, personal digital assistants (PDA), portable video game systems, tablet computers and the like. Almost all portable electronic devices feature a digital display screen such as an LCD display that facilitates control of the device by displaying text commands, options and images to a user. In addition to control functions, portable device screens are becoming increasingly responsible for providing display of photographs, playback of movies and the real-time action of video games. These devices are often sized so that they may be stored in a user's pocket or handbag. The size of most handheld portable electronic devices necessitates the use of small display components. This results in the presentation of text and images in small dimensions. The small size of visual depictions can be problematic for users with low vision or trouble seeing at close ranges. For these users, the control of their portable electronic device can be exceedingly difficult without the use of visual aids.

2. Description of the Prior Art

Common visual aids include hard magnifying lenses, flexible magnifying sheets (page readers) and digital magnification devices. These visual aids are clunky, hard to maneuver, or would require the user to hold the portable device in one hand and the visual aid in the other, leaving the user less capable of actually controlling the device or conducting another simultaneous activity. A lightweight, unobtrusive screen magnification device is needed to assist users with the control and magnification of portable devices

The prior art contains a variety of cellphone covers that provide magnification of a screen or keypad. These devices have familiar design elements for the purposes of magnifying components of a cell phone; however they are not adapted for the task of providing a user with customizable magnification strength and protecting a display screen from debris.

Some cases house at least a portion of a portable electronic device, such as Schure, U.S. Patent Application Publication No. 2006/0276220, which describes a rigid device having a front wall and a rear wall joined at the top to form a U-shaped cross-section. A rigid, magnifying window is disposed near the bottom of the front wall. The case slides down over the top of a cell phone such that the magnifying window is aligned with the screen of the cell phone.

Other available cases are flexible and encapsulate an entire cell phone. Brilliant et al, U.S. Patent Application Publication No. 2004/0204204 discloses a flexible case for a cell phone that has a removably securable flap along the top of the case. When the device is inserted and the flap is closed, the device is encapsulated within the case. A magnifying window is disposed on the front face of the case, over the area corresponding to a cell phone screen. This magnifying window is rigid to protect the screen from impact damage. A second magnifying window is disposed over an area corresponding to the cellphone keypad. The second window is flexible to permit depression of keys by a user. Neither of these devices discloses an adhesive film or a magnifying window that removably secures directly to the screen of a portable electronic device. Additionally the devices of Schure and Brilliant are not adaptable to fit portable electronic devices other than cellphones, unlike the current invention which provides an adhesive magnification window that can be used by a variety of electronic devices and screens.

Neither of the cases described by Schure and Brilliant disclose a flexible magnifier that can be removably secured directly to the screen of a cellphone. These devices provide ample openings for dust and dirt to accumulate on and around a display screen. The present invention provides a semi-flexible adhesive magnifier that can be applied directly to the screen of a phone to reduce the build-up of dirt and debris. Additionally, the present invention provides a modular screen frame of customizable height. By changing the height of the frame a user can change the focal length of the lens, thereby increasing or decreasing the offered power of magnification. The devices of Schure and Brilliant do not disclose customizable magnification capabilities.

The prior art also contains screen magnifying devices that cover just the screen area on a cellphone, rather than housing a portion of the device. Bartone, U.S. Pat. No. 6,985,311 discloses a magnifying window for a flip-top cellphone. The window comprises a magnification film secured within a plastic frame. The frame is secured to the top of the cellphone by extendable arms. A user can extend the arms to position the magnification window at a desired distance away from the phone screen. When the phone is closed, the arms collapse to flatten the device against the cellphone. Another such device is disclosed by Shaffer, U.S. Pat. No. 6,275,333. Shaffer contemplates a magnification window removably secured to a cellphone by a strap that wraps horizontally around the phone. The window has a slot on one side that is adapted to receive and retain a set of vertically stacked magnification slides. The slides may be inserted or removed to adjust magnification of objects on the phone screen. Neither the magnification window nor the slides is directly secured to the screen of the phone. The devices of Bartone and Shaffer do not disclose an adhesive magnifier that protects a display screen from dirt and debris. The present invention provides a film screen that secures directly to the screen of a portable device and therefore offers screen protection in addition to magnification.

A variety of adhesive screen protectors are also disclosed in the prior art. These protectors are thin and secure directly to the screen of a cell phone or other electronic device. Some devices have a dry adhesive coating on one side that is activated by water or other chemicals, such as the device disclosed in Mason Jr. U.S. Pat. No. 7,389,869. Other devices are self-adhering. Mason does not disclose a magnification function, unlike the present invention, which both protects a portable device screen and magnifies displayed images.

The devices disclosed by the prior art do not address the need for a customizable screen magnifier that protects the magnified display screen from debris and may be used with a variety of display types. The present invention relates to a device for magnifying the screen of a portable electronic device. It substantially diverges in elements from the prior art, consequently it is clear that there is a need in the art for an improvement to the known types of cellphone screen accessories. In this regard the instant invention substantially fulfills these needs.

### SUMMARY OF THE INVENTION

In view of the foregoing disadvantages inherent in the known types of cellphone screen accessories now present in the prior art, the present invention provides a new customizable magnification capability and screen protection function, wherein the same can be utilized for providing convenience for the user when reading the screen of a cellphone or other portable electronic device.

The present invention comprises a front surface, a rear surface and an overall rectangular shape adapted to fit the screen of an electronic device. It is constructed of a thin transparent material such as plastic. The front surface of the device is formed in the shape of a Fresnel lens having numerous concentric and annular sections. The device may be thin, nearly flat and somewhat flexible. The lens magnifies any object placed directly beneath the material. When the device is positioned over the screen of a portable electronic device, the text lying thereunder is magnified, making the text easier to read for a user with visual deficiencies. A user can adjust the power of magnification by changing the offset distance between the lens and the display screen. The farther the lens is moved from the display screen, the larger the underlying image becomes, as seen through the lens.

The rear surface of the device has an adhesive to removably secure the lens to a screen. In a preferred embodiment the adhesive is applied about the perimeter edges of the device, leaving the central portion of the lens rear surface free of adhesive. The magnifier can be affixed directly to a display screen by pressing the rear surface onto a display screen, while alternatively the distance between the display screen and the magnifier can be updated by attaching the lens to at least one frame component that attaches to the screen. These frame components are of approximately the same size and shape as the magnifier; however a large central portion is removed to allow vision through the frame, and thus allow the lens to operate in conjunction therewith. The resulting shape of the frame is a border around the display screen. Each frame component has a top surface and a bottom surface. The bottom surface is coated with adhesive such that the frame component can be removably secured to a display screen or to another frame component. Users can create stacks of frame components by securing the bottom surface of a first component to the top surface of a second component. Once a stack of desired height is created, the magnifier is secured to the top surface of the uppermost frame component. The stack can then be affixed to the display screen. Frame components can thus be added or removed from the stack to change the focal length of the magnifier lens. In this manner a user can customize the power of magnification they view. At the same time, the device prevents dust and debris from accumulating on the display screen. In an alternate embodiment, the frame may be comprised of an accordion-type design, wherein the offset distance between the lens and the display can be adjusted as necessary. This embodiment provides a device that can be condensed when not in use, and extended while being used to provide necessary magnification of the screen image.

It is therefore an object of the present invention to provide a new and improved electronic device screen magnifier having all the advantages of the prior art and none of the disadvantages.

Another object of the present invention is to provide a new and improved electronic device screen magnifier having a self-adhesive coating so that the magnifier may be removably secured directly to the surface of a display screen.

Still another object of the present invention is to provide a new and improved electronic device screen magnifier for magnifying the image depicted on a digital or analog display.

A further object of the present invention is to provide a new and improved electronic device screen magnifier that protects a display screen from scratching and accumulation of dust and debris.

A still further object of the present invention is to provide a new and improved electronic device screen magnifier that offers customizable power of magnification by allowing a user to manipulate the focal length of the magnifier.

A final object of the present invention is to provide a new and improved electronic device screen magnifier having resilient and durable construction.

Other objects, features and advantages of the present invention will become apparent from the following detailed description taken in conjunction with the accompanying drawings.

### BRIEF DESCRIPTIONS OF THE DRAWINGS

The above invention will be better understood and the objects set forth above as well as other objects not stated above will become more apparent after a study of the following detailed description thereof. Such description makes use of the annexed drawings wherein like numeral references are utilized throughout.

FIG. 1 shows a perspective view of a preferred embodiment of the present electronic device screen magnifier being applied directly to a cell phone screen.

FIG. 2A shows a perspective view of a preferred embodiment of the magnifier lens. An expanded view of the device is also shown, displaying the structure of the lens.

FIG. 2B shows an exemplary example of a preferred lens cross-section.

FIG. 3 shows a perspective view of an alternate embodiment of the present electronic device screen magnifier with a frame component secured to a cellphone to increase the focal length and therefore the size of a magnified image.

FIG. 4 shows a side view of a stack of frame components with the magnifier partially secured to the top of the stack.

### DETAILED DESCRIPTION OF THE INVENTION

Reference is made herein to the attached drawings. Like reference numerals are used throughout the drawings to depict like or similar elements of the electronic device screen magnifier. For the purposes of presenting a brief and clear description of the present invention, the preferred embodiment will be discussed as used for magnifying the images depicted on a display as well as protecting the display from scratching, dirt and debris. This is for representative purposes only and should not be considered to be limiting in any respect.

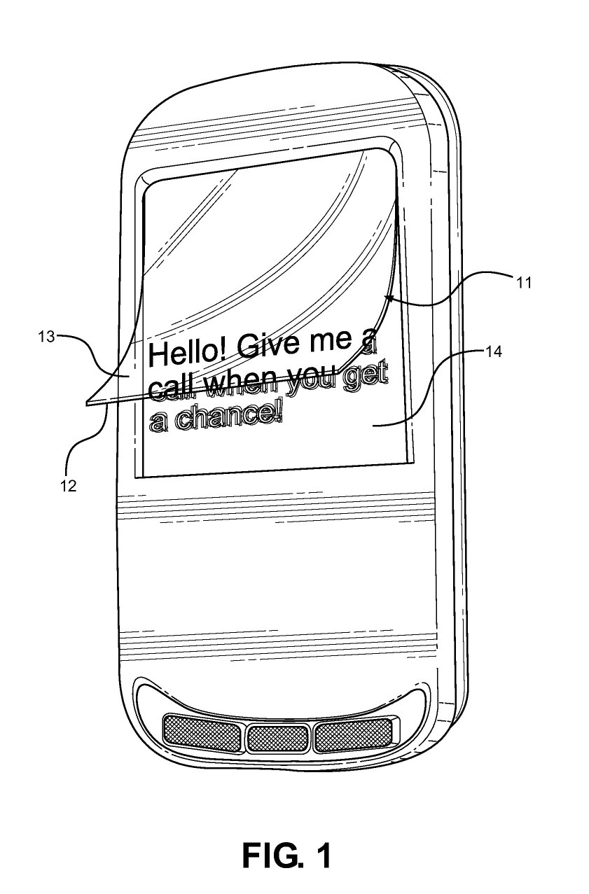

Referring now to FIG. 1, there is shown a preferred embodiment of the magnifier sheet 11 applied to the display 14 of a cell phone. The magnifier sheet 11 is made from a flexible, transparent material and has a front surface 13 and a rear surface 12 forming a semi-flat region therebetween. This region can be shaped like a rectangle, a circle or other geometric figure that may conform to the boundaries of an electronic device screen. The size and dimension of the sheet may vary to accommodate the screens of portable devices such as cellphones, pda's, portable video game systems, watches, tablet computers and the like.

The rear surface 12 of the magnifying sheet 11 has a coating of adhesive. In production of the device, a removable backing may be affixed to the rear surface of the device to protect the adhesive coating prior to its use. The backing is removed to expose the adhesive when an individual is ready to apply the sheet to a screen. A user affixes the magnifying sheet to a display by aligning the sheet with the display then gently pressing downward on the sheet. When the device is firmly in place, it provides protection to the associated display screen by acting as a barrier against dirt and debris. The device also reduces the likelihood that the display will be scratched. In this way, the magnification device also functions as a screen protector for a portable electronic device or other display. The screen protection capability will be useful to people who place their electronic devices in a purse, pocket or handbag, where it can be easily scratched by other objects.

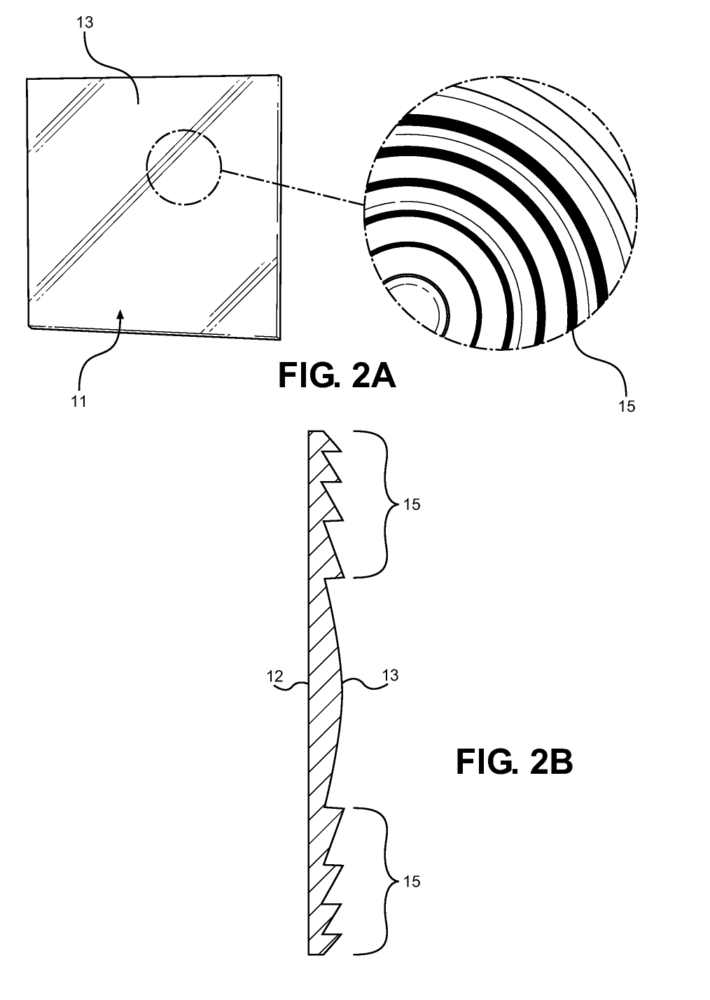

Referring now to FIG. 2A, there is shown an enlarged view of the front surface 13 of the magnifying sheet 11. The distance between a lens and the object of magnification is essential to determining the power of magnification provided by the lens. Because the distance between the magnifying sheet and the object being magnified is short, a Fresnel lens is employed. The lens has concentric annular rings 15 that expand outwardly from the center of the lens. In the center, the lens is gently convex. The slope of the concentric rings increases as the rings get farther from the center of the lens. However, the overall convex curvature is small due to the minimal thickness of the magnifying sheet. Consequently it may appear nearly flat to the naked eye.

In FIG. 2B there is shown a magnified side view of a Fresnel lens. The construction of the lens is not limited to the number of concentric ring sections shown in the figure or to the proportion or slope of those rings. The use of stepwise lens curvature permits the magnifying sheet to provide magnification, while remaining thin, flexible and lightweight, unlike conventional thick, hard lenses. This is advantageous to visually impaired portable device users who wish to minimize the bulk of associated visual aids.

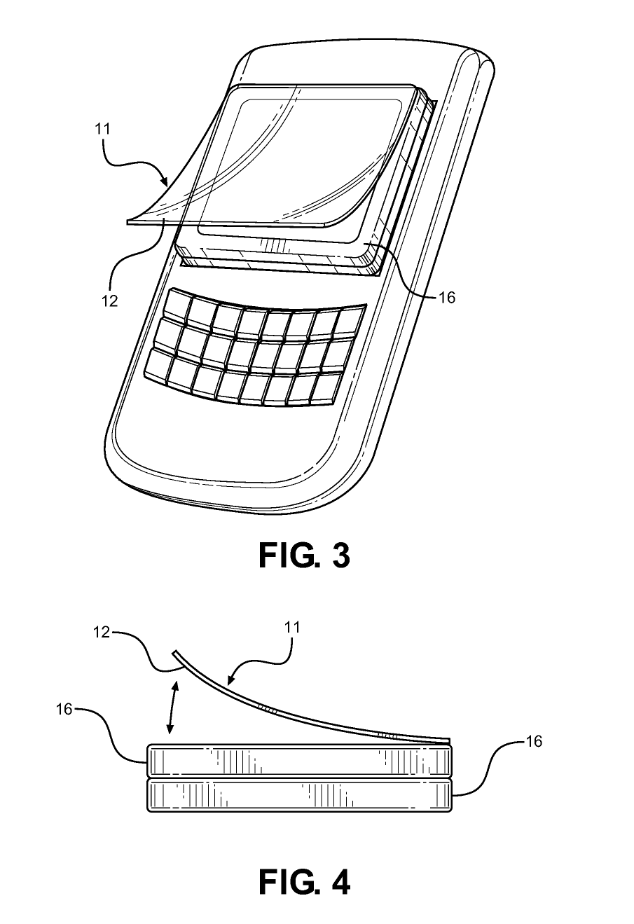

Referring now to FIG. 3 there is shown a perspective view of an alternate embodiment of the present invention, wherein a frame component 16 is positioned between the magnifier sheet 11 and a display. The frame component 16 has four walls defining an interior space and forming a border around the edges of a display screen. On the bottom surface of the frame is a coating of adhesive such that the frame can be removably secured directly to a portable device. The top surface of the frame component is removably secured to the rear surface 12 of a magnifying sheet 11. Text and images displayed on the display screen can be viewed through the interior portion of the frame component and are visually enlarged by the magnifying sheet.

In FIG. 4 there is shown a side view of a magnifying sheet 11 being secured to two frame components 16 stacked together. The bottom surface of a first frame component is removably secured to the top surface of a second frame component to create a stack. A magnifying sheet can then be secured to the top surface of the stack. By stacking frame components, a user can increase the offset distance between the magnifying sheet and a display screen. Increasing this distance increases the focal length, and thereby renders a higher power of magnification, increasing the size of text and images on the display as perceived by the user. Users can manipulate the magnification of displayed text by adding or removing frame components. This feature provides users with a customizable viewing experience to suit their particular visual aid needs. The frame components may be made of a depressible material such as foam, or a more rigid material such as plastic or rubber.

In an alternative embodiment, the frame components are extendable and retractable as desired by the user. The structure of the frame, through its thickness, employs an accordion-like structure between the top and bottom surfaces, which allows the frame component to be compressed onto the screen or upwardly extended. When the component is extended, the power of magnification is increased. This allows a user to extend the component to exactly the distance associated with a desired power of magnification. Users with very specific visual aid needs may find this embodiment desirable because it provides a larger range of available magnification than the non-extendable frame components. The ability to compress the frame into the device also improves portability of the device, as it is less bulky and less likely to snag articles while being transported or stored. This either embodiment of the frame, the lens is attached thereto via a perimeter of adhesive along its rear surface, as opposed to having adhesive along its entire rear surface.

In use, an individual selects a magnification sheet and removes the protective backing sheet from the rear surface of the magnification lens to reveal the adhesive. One edge of the sheet is positioned over a corresponding edge of a display on a portable electronic device. The user then gently presses the material of the magnification device onto the screen and slides his or her finger across the screen to an opposing edge. This process is repeated to smooth out the magnification sheet and ensure that all areas of the sheet adhere to the screen. The user may then power on the portable electronic device and check for inconsistencies in the application of the magnification material as evidenced by distortion in the magnification of on-screen text. Once the user is satisfied with the application of the device, no further action is needed and the device is ready for use as a display magnifier and screen protector.

The instant invention therefore provides a magnification device that can be customized by a user. The magnification sheet is the lens of the device and can be removably secured to the display of a portable device. To increase the magnification of on-screen images, a user can secure the sheet to at least one frame component, which is then secured to the display. This extends the offset distance between the lens and the object being magnified, and thus increases the size of the resulting image. A user can add or remove frame components as necessary to accommodate their needs. In any embodiment, the device prevents dirt and debris from getting onto the display by forming an adhesive seal therearound.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim the following:

1) A display magnifier and screen protector, comprising:
a magnifying sheet having a front surface and a rear surface, wherein said surfaces define a geometrically shaped region;
said magnifying sheet being formed into a Fresnel lens;
said rear surface having a coating of adhesive.

2) The device of claim 1, further comprising:
at least one frame component having four walls defining an interior open space, a top surface, and a bottom surface;
said bottom surface having a coating of adhesive;
said magnifying sheet rear surface being adhered to said at least one frame component top surface.

3) The device of claim 2, wherein said at least one frame components are stackable, wherein a bottom-most frame component bottom surface attaches to said screen and an upper-most frame component top surface is attached to said magnifying sheet.

4) The device of claim 2, wherein said frame components have a compressible accordion structure disposed between said top surface and said bottom surface.

5) The device of claim 2, wherein said frame component conforms to the perimeter shape of said magnifying sheet.

6) The device of claim 1, wherein said geometric shape is rectangular.

7) The device of claim 1, wherein said magnifier is constructed of a transparent material.

8) A display magnifier and screen protector, comprising:
a magnifying sheet having a front surface and a rear surface, wherein said surfaces define a geometrically shaped region;
said magnifying surface being formed into a Fresnel lens;
said rear surface having a coating of adhesive;
at least one frame component having four walls defining an interior open space, a top surface, and a bottom surface;
said bottom surface having a coating of adhesive;
said magnifying sheet rear surface being adhered to said at least one frame component top surface.

9) The device of claim 8, wherein said at least one frame components are stackable, wherein a bottom-most frame component bottom surface attaches to said screen and an upper-most frame component top surface is attached to said magnifying sheet.

10) The device of claim 8, wherein said frame components have a compressible accordion structure disposed between said top surface and said bottom surface.

11) The device of claim 8, wherein said frame component conforms to the perimeter shape of said magnifying sheet.

12) The device of claim 8, wherein said geometric shape is rectangular.

13) The device of claim 8, wherein said device is constructed of a transparent material.
